(19) United States
(12) Patent Application Publication
(10) Pub. No.: US 2011/0291818 A1
(43) Pub. Date: Dec. 1, 2011

(54) METHOD FOR STORING CONTROL SIGNALS OF REMOTE CONTROLLER AND ELECTRONIC DEVICE USING THE SAME

(75) Inventors: Yu-Hung Hsieh, New Taipei City (TW); Shou-Kuo Tai, New Taipei City (TW); Chia-Chen Chao, New Taipei City (TW)

(73) Assignee: AVERMEDIA TECHNOLOGIES, INC., Taipei (TW)

(21) Appl. No.: 13/050,187

(22) Filed: Mar. 17, 2011

(30) Foreign Application Priority Data
Jun. 1, 2010 (TW) 099117663

(51) Int. Cl. G08C 19/16

(52) U.S. Cl. 340/12.24

(57) ABSTRACT

The present invention provides a method for storing control signals and an electronic device using the method. An object thereof is receiving and storing control signals sent from a remote controller. The method comprises: using the electronic device to receive a first control signal sent from the remote controller by pressing a first key of the remote controller; performing a comparison program between the first control signal and a query record comprising a plurality of function options and a plurality of corresponding control signals; dynamically displaying a function option of the function options and a corresponding modification prompt according to a result of the comparison program; and updating and storing a control signal corresponding to the function option of the query record.

### FIELD OF THE INVENTION

The present invention relates to a method for storing control signals and an electronic device using the method, and more particularly to a method for storing control signals according to a result of a comparison program.

### BACKGROUND OF THE INVENTION

In the conventional art, when users employ computers to view programs from audio and video devices, it needs to connect signal lines of the audio and video devices with the computers, and further it also needs to employ corresponding remote controllers cooperated with the audio and video devices to perform related operations. Since the audio and video devices used by the users may comprise various kinds, the cooperated remote controllers are also different with different manufacturers and models, thus it will perplex the users in operation. Therefore, when the computers cooperate with the audio and video devices in current, the computer will provide the IR learning function mechanism such that the computers may record waves sent out from the various remote controllers, and simulate control signals sent out from the remote controllers to send out another control signals according to the emitting waves of the remote controllers controlling the audio and video devices. Therefore, the users can employ user interfaces of the computers to directly process the audio and video devices without additional remote controllers to control the audio and video devices.

FIG. 1(A) is a block view of a system with an IR learning function. The system comprises a remote controller and a terminal device, which are communicated with each other through signals. The terminal device 11 comprises a computer 111 and a TV card 113 configured for cooperating with an audio and video device (such as a step-top box (STB) 12) to watch audio and video programs. When a user performs general operations, the user uses the remote controller 13 to operate the audio and video device. Furthermore, transceivers 1131, 121 between the remote controller 13 and the audio and video device are in communication through control signals defined by manufacturers.

Since idle times of the user are not always cooperated with play times of the audio and video programs, the terminal device such as the computer is developed to learn the method for sending the control signals from the remote controller 13. The method firstly uses the computer to learn the control signals sent from the remote controller 13, and then uses the computer to send out simulative control signals to the audio and video device. Therefore, the user can use the computer to control the audio and video device without using the remote controller 13.

FIG. 1(B) is a flow chart of using the remote controller to control the audio and video device for playing the audio and video programs. The remote controller sends out the control signals to control the audio and video device (step S11), and then the audio and video device plays the audio and video programs according to the received control signals (step S12).

FIG. 1(C) is a brief flow chart of a method for applying a software to learn from the remote controller. As described in the above, the method mainly employs the computer to simulate the control signals used for controlling the audio and video device, such that the computer can directly send out the control signals used for operating the audio and video device, to the audio and video device. In other words, the computer needs to employ the software to provide function options used for controlling the audio and video device, and to make the function options to be corresponded with function keys of the remote controller.

Generally, for allowing the computer to obtain formats of the control signals sent from the function keys when the remote controller controls the audio and video device, the computer cooperates with the transceiver (the transceiver may be built-in or externally attached), and then the terminal device can be used for receiving the control signals corresponding to the function keys of the remote controller through the transceiver and the application software (step S13). Then the user can employ the application software of the computer to control the transceiver, such that the terminal device directly sends out the control signals to the audio and video device through the transceiver (step S15). The audio and video device receives the control signals sent from the computer which simulates the remote controller, to start performing the general audio and video play function, and transmits the audio and video programs to the terminal device through a corresponding audio and video signal line to be displayed (step S17). In other words, it is the terminal device for actually controlling the audio and video device to perform the audio and video playing function, instead of the remote controller.

It should be noted that, the IR learning method as shown in FIG. 1(C) comprises a flow for learning the keys of the remote controller and a following application flow for operating the audio and video device. Therefore, the flows as shown in FIG. 1(C) do not always take place in a same period. For example, the user may perform the flow of learning the functions of the remote controller just after buying the TV card or the image pick-up card, but the user may perform the flow of employing the computer to send out the simulative signals to control the STB 12 at a week after buying the TV card. If the user wants to perform a scheduled kinescoping function at the moment, the user may define a scheduled kinescoping period at the computer. If a corresponding scheduled condition takes place, the computer automatically starts a related scheduled flow to send out the simulative control signals to the STB, to perform an automatic operation.

Although the learning function of the software improves the problems of the remote controller with different kinds and scheduled controlling the audio and video device, the key learning function provided by the software is deficient because the current operation of the software learning the functions of the remote controller is inconvenient for the user employing the terminal device to record the control signals corresponding to the keys of the remote controller.

At present, the flow of the software learning the remote controller, mainly comprises a semi-automatic learning mode provided by the Hauppauge software, and a full-automatic learning mode of the Media Center Edition (MCE) provided by the Microsoft. The two learning modes for the functions of the remote controller, and the disadvantages thereof, are described as follows.

The semi-automatic learning mode comprises the steps of: displaying the software on an operation interface firstly, prompting the software which of the keys of the remote controller should be inputted, then pressing a corresponding key of the remote controller by the user. In other words, the user must firstly click a key of the software, then press the corresponding key of the remote controller to learn, over and over again. Therefore, the learning mode is considerably complex.

On the other hand, the full-automatic learning mode comprises the steps of: predefining a whole key learning flow, displaying key learning prompts which should be learned in sequence by the predefined key learning flow, and step by step performing the key learning operations according to the key learning prompts displayed by the software. The disadvantage of the key learning mode is that the user must press the keys of the remote controller according to the steps predesigned by the software, thus the user is passive to cooperate and is inconvenient during the whole key learning period.

For example, the current full-automatic learning mode must switch a next page to continuously learn a next function option after inputting a key every time. If the user occasionally wants to modify a first function option when the user inputs a tenth key, the user must step by step return to the first function option from a ninth function option, an eighth function option, . . . After the user modifies the first function option, the user must repeat to perform the key function design from a second function option, etc. Therefore, the IR learning mode must go back and forth to perform the unnecessary operations, thus it is very inconvenient.

From the above it can be seen that, although the present learning modes of the software learning the function keys of the remote controller can use the computer to control the audio and video device instead of the remote controller, the conventional modes are considerably limited and are inconvenient. The present invention is used to improve the above disadvantages.

### SUMMARY OF THE INVENTION

The present invention provides a method for storing control signals adapted into an electronic device and configured for receiving and storing control signals sent from a remote controller. The method comprises: using the electronic device to receive a first control signal sent from the remote controller by pressing a first key of the remote controller; performing a comparison program between the first control signal and a query record comprising a plurality of function options and a plurality of corresponding control signals; dynamically displaying a function option of the function options and a corresponding modification prompt according to a result of the comparison program; and updating and storing a control signal corresponding to the function option of the query record.

Preferably, the step of using the electronic device to receive the first control signal sent from the remote controller by pressing the first key of the remote controller, comprises: pressing the first key according to a pending input function option by a user; and using the electronic device to receive the first control signal corresponding to the first key which is sent from the remote controller.

Preferably, the function options of the query record are divided into a plurality of pre-stored function options and a plurality of pending-input function options.

Preferably, the step of dynamically displaying the function option of the function options and the corresponding modification prompt according to the result of the comparison program, comprises: displaying a pending-input function option and a modification prompt clashed with a pre-stored function option corresponding to the first control signal of the query record, if the result is a repeated result; and displaying a modification prompt for storing the first control signal as the pending-input function option.

Preferably, the step of displaying the pending-input function option and the modification prompt clashed with the pre-stored function option corresponding to the first control signal of the query record if the result is the repeated result, comprises: displaying the repeated result through a prompt information; and optionally modifying a control signal corresponding to the pre-stored function option or a control signal corresponding to the pending-input function option according to the prompt information by the user.

Preferably, the step of updating and storing the control signal corresponding to the function option of the query record, comprises: receiving a second control signal sent from the remote controller by pressing a second key of the remote controller; and updating the control signal corresponding to the pre-stored function option as the second control signal, or storing the second control signal as the control signal corresponding to the pending-input function option, according to a judgment for the prompt information by the user.

Preferably, the repeated result is that the query record has stored a corresponding relation between the first control signal and the pre-stored function option.

The present invention also provides a computer-program product comprising a software program stored therein. The software program is performed to perform an operation for storing a control signal by an electronic device having a control unit. The operation for storing the control signal comprises: using the electronic device to receive a first control signal sent from a remote controller by pressing a first key of the remote controller; performing a comparison program between the first control signal and a query record comprising a plurality of function options and a plurality of corresponding control signals; dynamically displaying a function option of the function options and a corresponding modification prompt according to a result of the comparison program; and updating and storing a control signal corresponding to the function option of the query record.

The present invention also provide an electronic device connected to a remote controller through signals and having a function of storing control signals sent from the remote controller. The electronic device comprises a transceiver, connected to the remote controller through the signals, and configured for receiving a first control signal sent from the remote controller by pressing a first key of the remote controller; and a control unit, electrically connected to the transceiver, and configured for performing a comparison program between the first control signal and a query record comprising a plurality of function options and a plurality of corresponding control signals, and updating and storing a control signal corresponding to a function option of the function options of the query record, after dynamically displaying the function option of the function options and a corresponding modification prompt according to a result of the comparison program.

Preferably, the electronic device further comprises a display unit, electrically connected to the control unit, and cooperated with the control unit to dynamically display the function option and the corresponding modification prompt.

Preferably, the electronic device further comprises a memory unit, electrically connected to the control unit, and configured for updating and storing the query record according to the comparison program performed by the control unit.

Preferably, the memory unit employs a lookup table mode or a linking list mode for storing a corresponding relation between the plurality of function options and the plurality of control signals of the query record.

Preferably, the step of the control unit dynamically displaying the function option of the function options and the corresponding modification prompt according to the result of the comparison program, comprises: displaying a pending-input function option and a modification prompt clashed with a pre-stored function option corresponding to the first control signal of the query record if the result is a repeated result; and displaying a corresponding modification prompt for storing the first control signal as the pending-input function option if the result is an updated result.

Preferably, if the result is the repeated result, the control unit performs following steps: displaying the repeated result through a prompt information; and optionally modifying a control signal corresponding to the pre-stored function option or a control signal corresponding to the pending-input function option according to the prompt information by the user.

Preferably, the step of the control unit updating and storing the control signal corresponding to the function option of the query record, comprises: receiving a second control signal sent from the remote controller by pressing a second key of the remote controller; and updating the control signal corresponding to the pre-stored function option as the second control signal, or storing the second control signal as the control signal corresponding to the pending-input function option according to a judgment for the prompt information by the user.

Preferably, the repeated result is that the query record has stored a corresponding relation between the first control signal and the pre-stored function option.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1(A) is a block view of a system with a remote controller learning function.

FIG. 1(B) is a flow chart of a remote controller controlling an audio and video device to play audio and video programs.

FIG. 1(C) is a brief flow chart of a method for applying a software to learn from the remote controller.

FIG. 2 is a block view of a system with a remote controller key learning function in accordance with an exemplary embodiment the present invention.

FIG. 3(A) is a brief flow chart of a method of using the software of the terminal device, such as the computer, etc., learning a remote controller key function in accordance with an exemplary embodiment of the present invention.

FIG. 3(B) is a detail flow chart of a step S31.

FIG. 3(C) is a detail flow chart of a step S33.

FIG. 3(D) is a detail flow chart if a result of performing the comparison program by the step S33 is a repeated result.

FIGS. 4(A)˜4(D) are schematic views for displaying images of the software provided by the electronic device performing the remote controller key learning function.

FIGS. 5(A)˜5(B) are flow charts of methods of using the electronic device to employ the application software for performing the remote controller key learning function.

FIG. 6(A) is a schematic view of using a lookup table to build a query record in accordance with the present invention.

FIG. 6(B) is a schematic view of using a linking list to build a query record in accordance with the present invention.

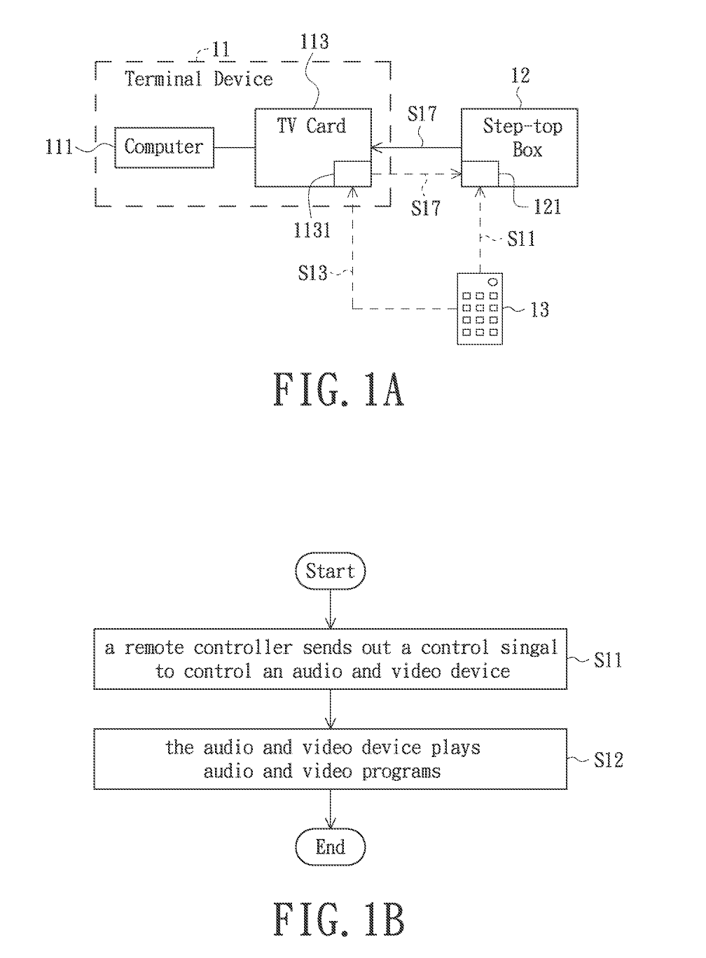

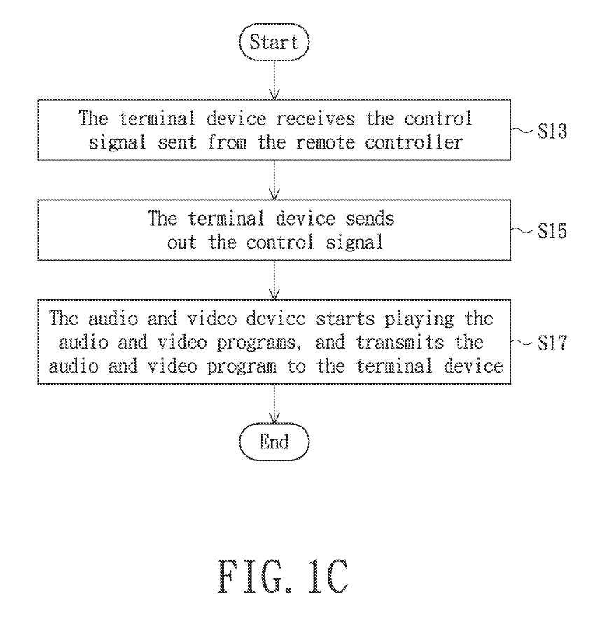

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

For the semi-automatic key learning mode or the full-automatic key learning mode, the conventional remote controller key learning modes still has many disadvantage, and the above key learning are not intuitional and inconvenient in operation. The present invention is used to improve the conventional key learning modes of the computer terminal, and to provide a facile remote controller key learning mode.

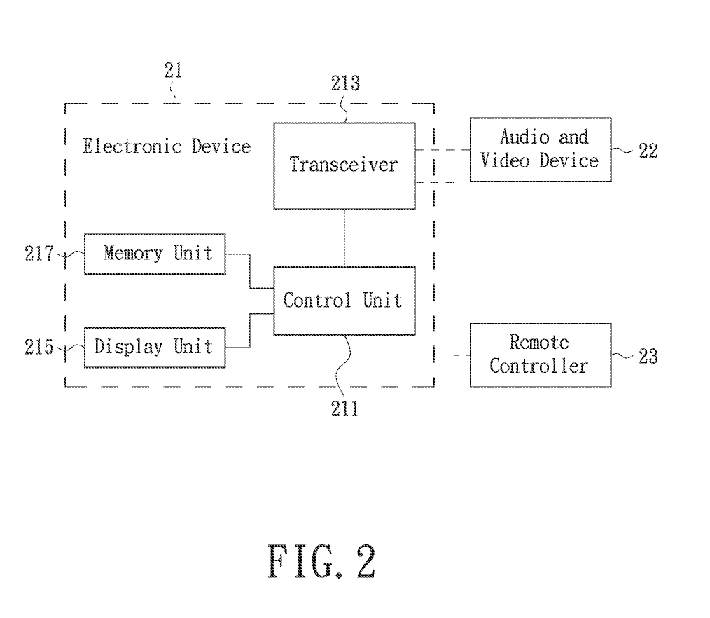

FIG. 2 is a block view of a system with a remote controller key learning function in accordance with an exemplary embodiment the present invention. The present invention is mainly configured for improving a key learning mode at a computer terminal and a display mode thereof, thus the system of the present invention is similar with that of the prior art.

An electronic device 21 of the present invention is connected to a remote controller 23 through signals. The electronic device 21 is configured for providing a function for storing control signals sent from the remote controller 23, such that the user can then directly use the electronic device 21 to control an audio and video device 22 without the remote controller 23 which is inconvenient in use.

From FIG. 2 it can be seen that, the electronic device 21 mainly comprises a transceiver 213 and a control unit 211, which is connected to a transceiver 213 of the remote controller 233 through the signals. Thus the electronic device 21 can receive control signals sent from the remote controller by pressing corresponding keys of the remote controller 23.

The electronic device 21 of the present invention mainly employs the control unit 211 electrically connected to the transceiver 213, to perform a remote controller key learning function. After the transceiver 213 receives the control signals corresponding to the keys of the remote controller 23, the control unit 211 will perform a judging operation needed by the key learning mode.

The electronic device 21 further optionally comprises a display unit 215 and a memory unit 217 except for the transceiver 213 and the control unit 211, and the control unit 211 is electrically connected between them. The display unit 215 is cooperated with the control unit 211 to dynamically display a function option and a modification prompt in relation to a corresponding control signal. The memory unit 217 is configured for storing a query record of a corresponding relation between the function option and the control signal, which is cooperated with a comparison program of the control unit 211 to update and store the query record according to a result of the comparison program.

When the control unit 211 performs the remote controller key learning function, it firstly performs a comparison program between a first control signal and a query record comprising a plurality of function options and a plurality of corresponding control signals, and updates and stores a control signal corresponding to a function option of the query record after dynamically displaying the function option of these function options and a corresponding modification prompt.

In addition, the electronic device 21 is a device with receiving and learning functions, and is not limited in its shape. In actual application, the electronic device 21 may be a computer with a built-in receiving function, or a computer externally connected to a TV card or an image pick-up card, or a computer with a transceiver electrically connected to a USB terminal, or a small and independent embedded product.

For the external operation flow among the audio and video device 22, the remote controller 23 and the electronic device 21, the present invention is similar with the conventional key learning flow, and it will not describe the external signal exchanging method herein. In other words, the main principle of the present invention is modifying the detailed flow of the application program of the computer recording the keys of the remote controller and the formats of the control signals sent therefrom, that is, the present invention mainly improves the details of the step S13 of the conventional control methods.

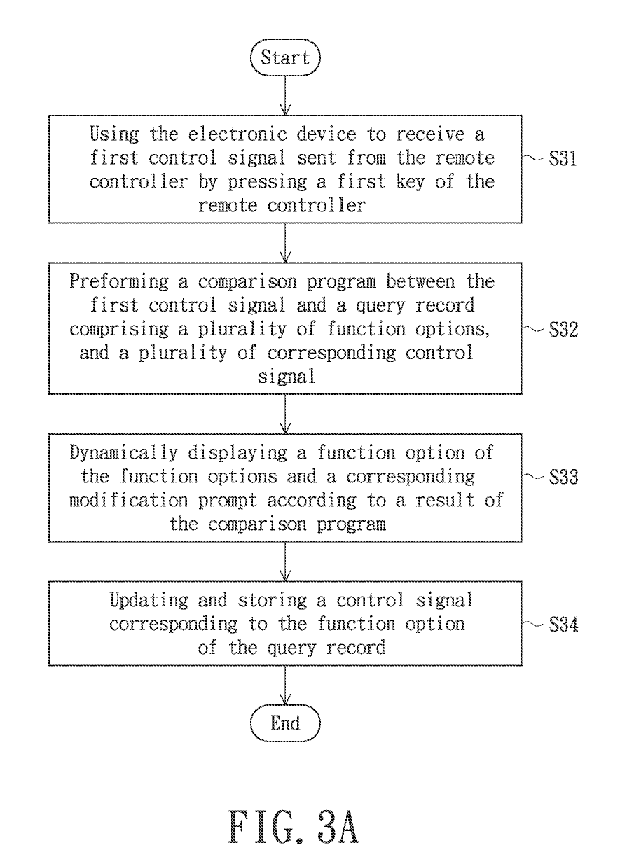

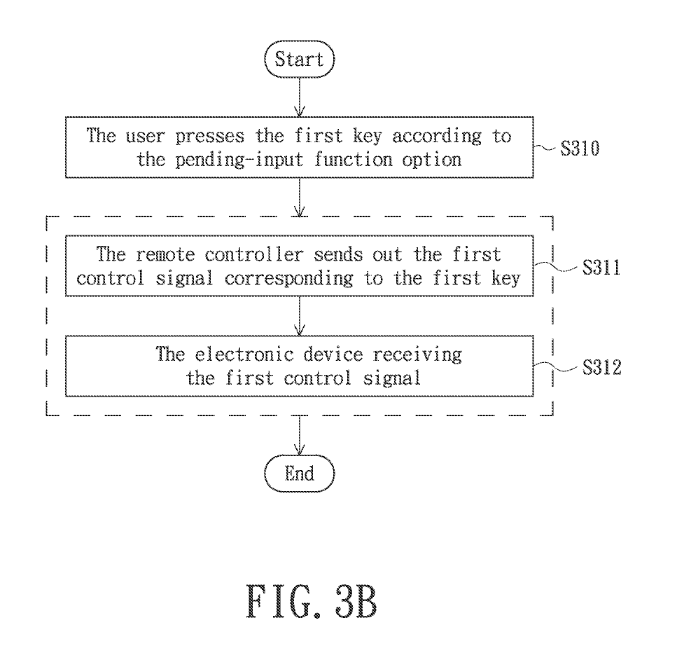

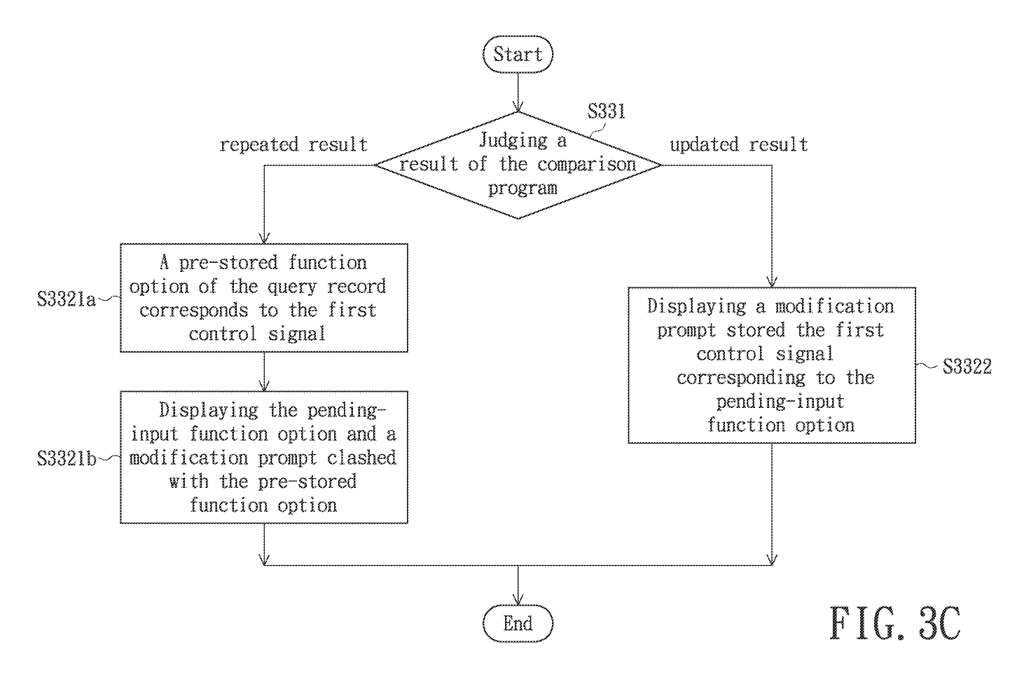

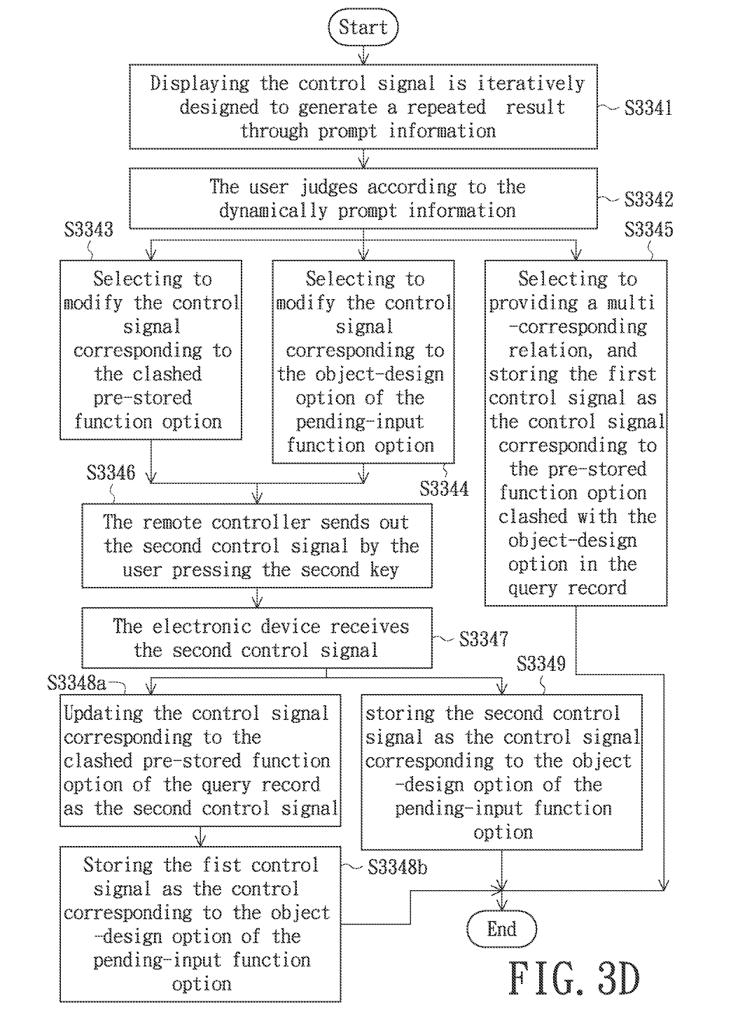

FIG. 3(A) is a brief flow chart of a method of using the software of the terminal device, such as the computer, etc., learning a remote controller key function in accordance with an exemplary embodiment of the present invention. From FIG. 3(A) it can be seen that, the method comprises: using the electronic device to receive a first control signal sent from the remote controller by pressing a first key of the remote controller (step S31); performing a comparison program between the first control signal and a query record comprising a plurality of function options and a plurality of corresponding control signals (step S32); dynamically displaying a function option of all the function options and a corresponding modification prompt according to a result of the comparison program (step S33); and updating and storing control signals corresponding to some of the function options of the query record according to a judgment by the user (step S34).

Although FIG. 3(A) has described the main principle of the present invention, each of the steps of the control method may be divided into different steps according to different judgments and decisions by the user in operation, in actual application.

FIG. 3(B) is a detail flow chart of the step S31. From FIG. 3(B) it can be seen that, the step S31 may further comprises: pressing the first key by the user according to an object-design option of a pending-input function option (step S310), sending out the first control signal corresponding to the first key by the remote controller according to the first key pressed by the user (step S311); and employing the transceiver of the electronic device to receive the first control signal sent from the remote controller (step S312).

FIG. 3(C) is a detailed flow chart of the step S33. The step S33 may be divided into two processing modes according to the result of the comparison program performed by the software for the query record.

If the comparison program generates a repeated result, it represents the query record has stored at least one pre-stored function option, which has been defined to correspond to the first control signal (step S3321a). Thus it will display a pending-input function option and a modification prompt clashed with the pre-stored function option of the query record corresponding to the first control signal (step S3321b).

On the other hand, if the result generated by the comparison program is an update result, it will display a modification prompt for storing the first control signal as the corresponding pending-input function option (step S3322). If the result generated by the comparison program is the update result, the application program performs a step S34 to update and store a corresponding relation between the object-design option and the first control signal in the query record. That is, the first control signal is stored as the control signal corresponding to the object-design option.

FIG. 3(D) is a detail flow chart when the result of the comparison program performed by the step S33 is the repeated result. Since the result of the step S33 will influence the storing and updating conditions of the query record in the step S34, the following explanation of the process also comprises the process steps of the step S34.

A prompt information is firstly used to display that the control signal has been iteratively set previously, and the repeated result is represented through the prompt information (step S3341). The user judges the subsequent process according to a need for the key function design after the user watches the dynamical prompt information displayed on the display screen (step S3342). The following control flow may be divided into three modes according to different flow judging results.

A first mode is that the user wants to use the present input design. That is, the first control signal is stored as the control signal corresponding to the object-design option in the query record. Therefore, the application software needs to update the first control signal corresponding to the original pre-stored function option is the function option of the query record. The second mode is that the user regards the operation of pressing the first key as a wrong operation. At the moment, the user may need to repeat to press another function key function (second key) of the remote controller, and store a second control signal corresponding to the second key as the control signal corresponding to the object-design option of the query record. A third mode is that the user thinks the clashed pre-stored function option of the function options and the present object-design function option should both correspond to a same function key (the first key) of the remote controller. Therefore, it will directly update the control signal corresponding to the object-design option in the query record, and update the attribute of the object-design option as the kind of the pre-stored function option from the kind of the pending-input function option.

For clearly understanding the operations corresponding to the above three different judging modes, further detailed description is provided in the following as shown in FIG. 3(D).

In the first mode, the user thinks the previous operation for the pre-stored function option is wrong, and decides to correct the control signal corresponding to the pre-stored function option stored in the query record. That is, it updates the control signal corresponding to the pre-stored function option as the first control signal, and further input the second control signal as the control signal corresponding to the pending-input function option. The present flow comprises the following steps.

The user optionally modifies the control signal corresponding to the clashed pre-stored function option (step S3343). The remote controller sends out the second control signal by the user pressing the second key (step S3346). The electronic device correspondingly receives the second control signal (step S3347). Finally, the electronic device updates the control signal corresponding to the clashed pre-stored function option of the query record as the second control signal (step S3348a), and stores the first control signal as the control signal corresponding to the pending-input function option (step S3348b).

The process mode of the second mode represents the operation of the user pressing the first key is a wrong operation, it needs the user to further press the second key, and stores the second control signal sent from the remote controller by pressing the second key as the control signal corresponding to the pending-input function option. The present flow of the second mode comprises the following steps.

It modifies the control signal corresponding to object-design option included in the pending-input function option (step S3344). Then the user presses the second key of the remote controller, such that the remote controller sends out the second control signal correspondingly (step 3346). The electronic device receives the second control signal corresponding to the second key (step S3347). It represents the user does not want to modify the control signal corresponding to the pre-stored function option of the query record, and stores the second control signal as the control signal corresponding to the object-design option of the pending-input function option when updating the query record stored in the memory unit (step S3349).

For the third mode, it represents the user wants to correspond a same function key of the remote controller to a plurality of function options. Thus the clashed function option of the pre-stored function option and the present selected object-design option both correspond to the first control signal, it will store the control signal corresponding to the object-design option of the query record as the first control signal (step S3345).

The user also may employ a mouse to click the function options displayed on the display screen. Not only the pending-input function option which is not designed to corresponding to a key, but also the pre-stored function option which has been designed, can employ the method of the present invention to dynamically modify, thus it can improve the problems of the conventional art, that it is complex for modifying the control signal corresponding to the pre-stored function option of the query record.

The present invention provides the query record, which is used for dynamically determining whether the function design is clashed when the user inputs the option of the remote controller. When determining the function design is clashed, it can make the user instantly notice the design is clashed, and provide a comparison result by a dynamically information. Therefore, it will omit the complex steps of the key function learning mode, and not repeat to design the function keys without wrong designs during the design process. Therefore, it is intuitive when the user employs the application program to perform the key learning function, and greatly decreases the error of repeating to input the same control signal.

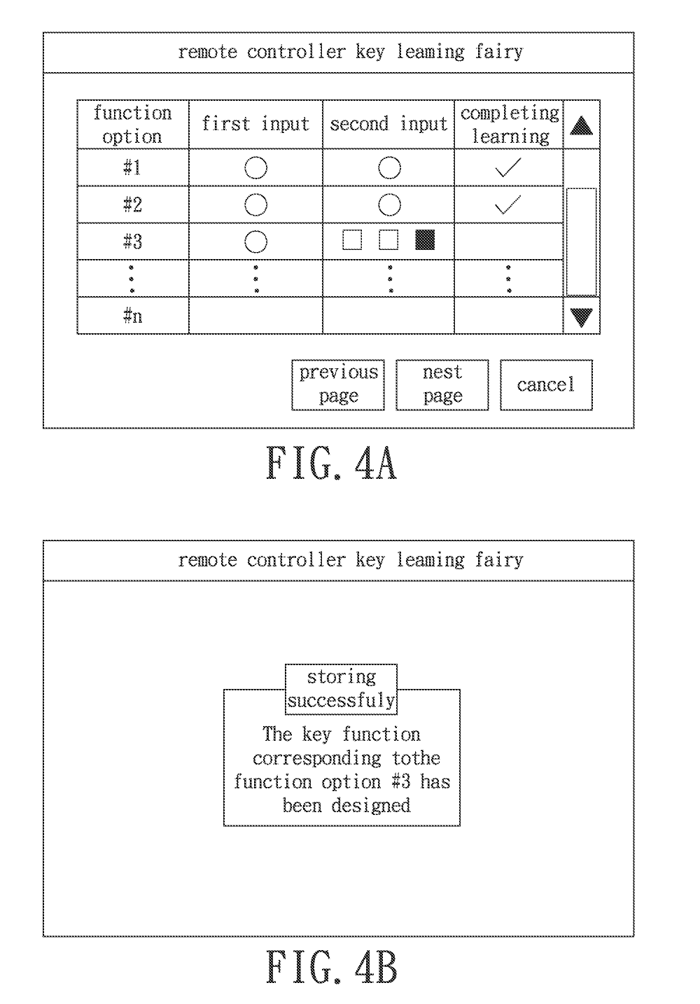

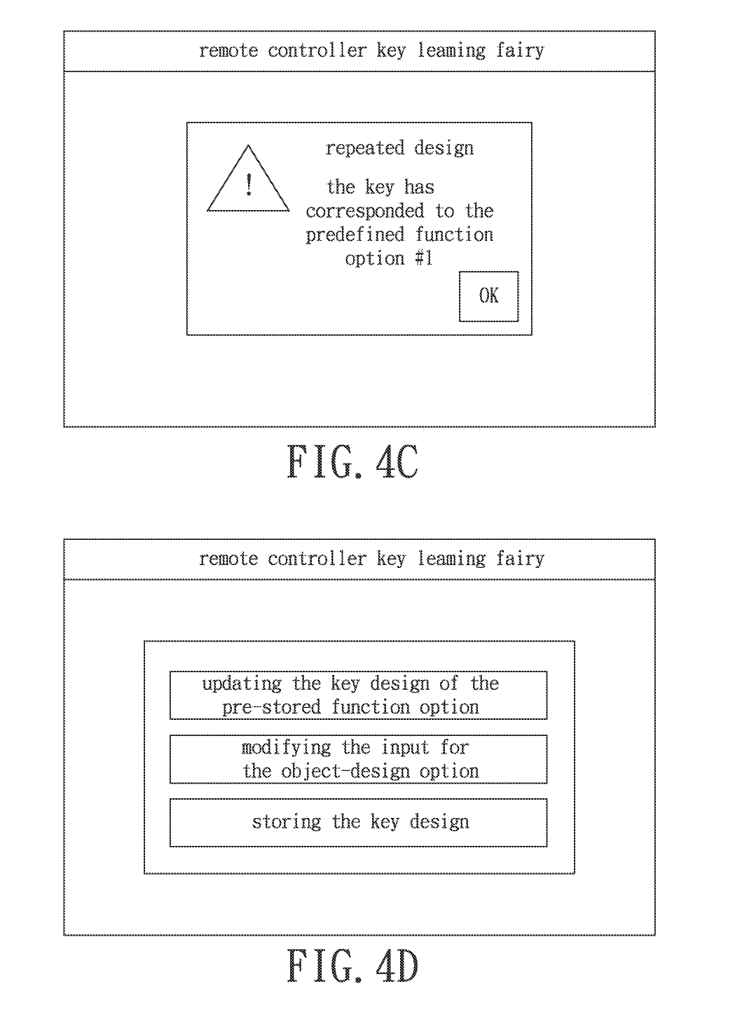

FIGS. 4(A)˜4(D) are schematic views for displaying images of the software provided by the electronic device performing the remote controller key learning function. In an exemplary embodiment, the computer may provide a remote controller key learning fairy by the application software, to provide an interactive interface when the user performs the key function learning operation.

In an image for displaying the remote controller key learning fairy of FIG. 4(A), it shows the function options as a table to the user. The application software can employ a pane to emphasize the selected function option which should be designed, or employ the mouse to select. According to the key pressed by the user, the remote controller key learning fairy will provide two input confirmations. If the user inputs a same function key (the first key) at the first input and the second input, it represents the function key input is confirmed iteratively. Thus it will be displayed in a corresponding field after completing the learning operation. It also can display the rate of receiving the input control signals by a horse-race lamp mode in other input processes.

As shown in FIG. 4(A), the remote controller learning fairy can employ a flexible user interface, such as providing a roller operation or cooperating functions, such as a previous page, a next page or cancel. In addition, when displaying a pending-design function option, it can use a same image to show all of the function options. Of course, it also can show the function options with different kinds on different image. Those are methods for employing the software to perform the additional functions, and it is not described herein.

In FIG. 4(B), the function key inputted by the user has not been designed and stored, that is, the query record does not pre-store the first control signal sent from the function key of the pre-stored function option as the corresponding control signal. The remote controller key learning fairy dynamically displays the prompt information that the store is succeed.

In FIG. 4(C), the query record has recorded a relation between the first press-key inputted by the user and a corresponding control signal, and the display screen displays a prompt information at the moment, to notice the user that the comparison program generates the repeated result, and provide a following process of the options as shown in FIG. 4(D).

In FIG. 4(D), the remote controller key learning fairy provides three options of the following processes according to the judgment of the user. The three options are used to cooperate with the above three flows as shown in FIG. 3(D), which are making the user optionally update the clashed key designs of the pre-stored function option; modifying the prompt of the object-design option; and performing a design corresponding to a plurality of storing keys.

Although the above operation employs the computer to perform the key learning method, the present invention also can employ other electronic device instead of the computer to perform the software with the key learning function in actual application. In other words, the present invention can be applied into any computer-program product which stores the software program. When the software program is performed, the electronic device having the control unit can perform the method for storing the control signal.

Similar with the method applied into the computer, the method for storing the control signal applied into other computer-program product with the electronic device comprises: using the electronic device to receive a first control signal sent from the remote controller by pressing a first key of the remote controller; performing a comparison program between the first control signal and a query record comprising a plurality of function options and a plurality of corresponding control signal; dynamically displaying a function option of the function options and a corresponding modification prompt according to a result of the comparison program; and updating and storing a control signal corresponding to the function option of the query record.

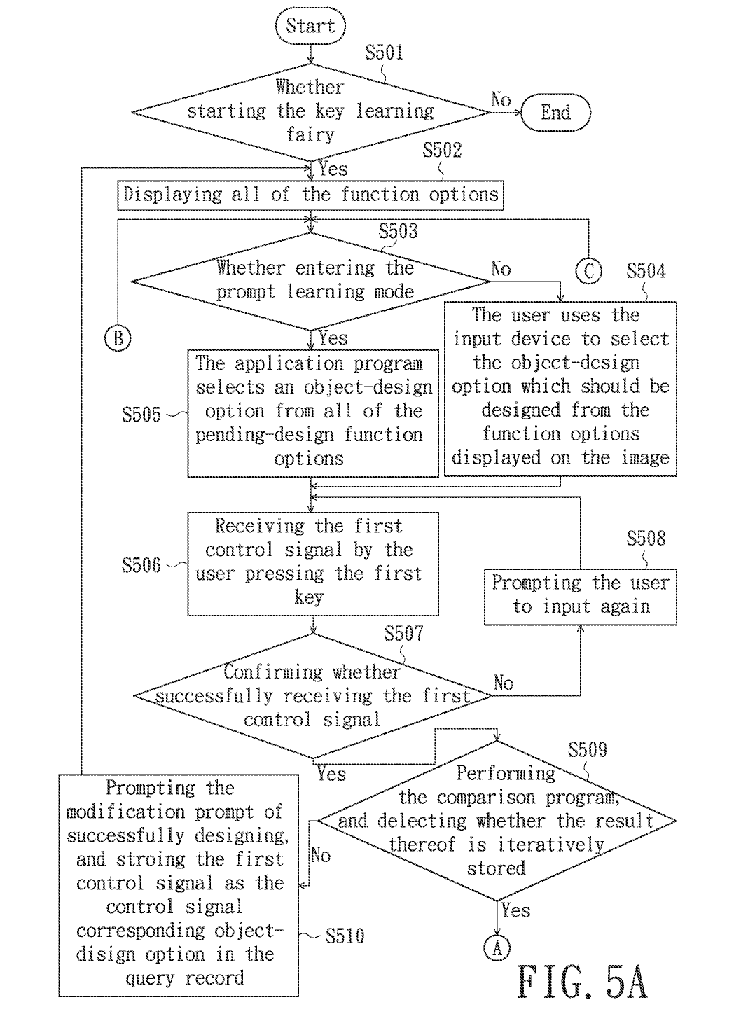

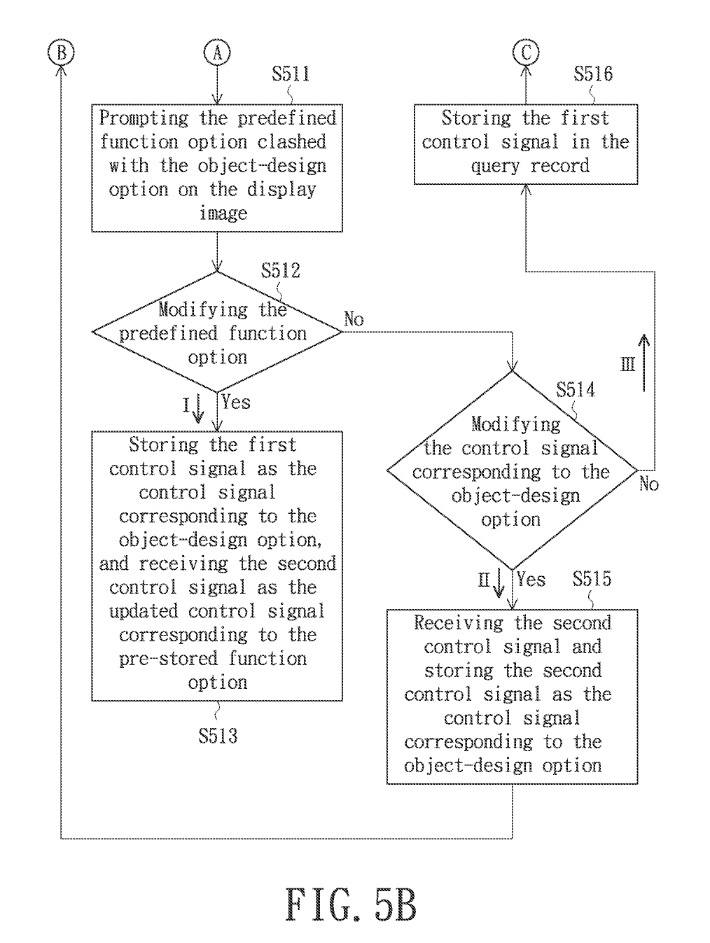

FIG. 5(A) and FIG. 5(B) are flow charts of methods of using the electronic device to employ the application software for performing the remote controller key learning function. The main principle of the method as shown in FIG. 5 is same to that of FIG. 3, except further increasing some judging and operating steps, such that the user can flexibly use the remote controller learning function.

The user firstly confirms whether starting the key learning fairy to enter the key learning flow (step S501). If yes, all of the function options are displayed on the computer screen (step S502), and if no, it ends the related function key design flow.

After displaying all of the function options, the user can determine whether entering the prompt learning mode according to the actual need (step S503). The prompt learning mode is that the software of the computer actively shows the pending-design function option of the function options in sequence dynamically. That is, the computer selects a next function option which should be learned.

If the user selects not to enter the prompt learning mode, it represents the user wants to design and select the function options according to a preferred sequence thereof. Therefore, the user can employ the input device such as the mouse or the keyboard, etc., to optionally select anyone of the undersigned function options of the function options displayed on the screen (step S504).

On the other hand, if the user selects to enter the prompt learning mode, the learning flow provided by the computer starts according to a predefined design flow, which may be decided by attributes of a key group. For example, when designing number keys, it will provide function options of the number keys in sequence, which are designed by the user respectively. When performing the step, the function options designed by the computer, can be reversed whitely or twinkled to emphasize the object-design option on the display image of the computer.

Of course, the method for entering the prompt learning mode does not need the specific operations to be switched. For example, the system may be predefined to employ the prompt learning mode, but if the user automatically select other function options in the image, it represents the user wants to design the selected function option. The present invention is not limited in the constant learning mode.

No matter what of the learning modes, once selecting a next function option which should be designed, the user then selects and presses the key (the first key) of the remote controller, and the computer receives the first control signal sent from the remote controller corresponding to the first key thereof (step S506).

There are problems of receiving the control signal because of the receiving angle, etc., when transmitting the control signal, therefore it may first confirm whether the control signal is entire (step S507), and prompt the user to perform the input operation for the function option again when the received control signal cannot be identified (step S508).

Once the control signal inputted by the remote controller is successfully received, the application program of the computer will compare the inputted first control signal with the previous query record, to judge whether the key pressed by the user is the function key which has been designed. That is, it is whether the repeated store takes place (step S509). If not building the query record, that is, the user performs the key function design corresponding to the first function options, it needs not to enter the comparison program

When the result of the comparison program is not, it represents the function key indeed corresponds to a pending-input function option which has not designed as a corresponding control signal. Therefore, it can increase a corresponding function in the query record (step S510).

On the other hand, if the result of the comparison program shows that it has stored a pre-stored function option corresponding to the control signal sent from a same function key, the key learning software displays a prompt information on a display image, to notice the user that the first control signal has been designed and it takes place a condition that the object-design option is clashed with the pre-stored function option (step S511).

If the application program detects the function key inputted by the user is clashed with the previous query record by the comparison program, it will provide a function of modifying the query record, such that the user can determine whether modifying the pre-stored function option according to the actual need of the user (step S512), or updating in the query record after modifying the input (step S514).

According to the judgment of the user, the following flow may be divided into three modes, which comprises a sub-flow I of modifying the control signal corresponding to the pre-stored function option by the user, which is shown in a step S513; a sub-flow II of modifying the design of the object-design option since the user thinks the input key is wrong, which is shown in a step S515; and a sub-flow III of defining the functions are pooled, which is shown in a step S516 to provide a storing design.

For further describing the above judgment flow, the following will employ an embodiment to auxiliarily describe the principle of the present invention. In the key learning process, when detecting the current input key function is iterative (clashed) with the previously input key function when comparing the record of the key function, there may be three different possibilities.

A first possibility (the sub-flow I) is that the key previously pressed by the user is wrong, and the current input option is a correct function key. For example, when the display image displays the number key 3, the user mistakes to input the number key 6 of the remote controller. Therefore, when the display image displays the input of the number key 6, if the user presses the number key 6 of the remote controller at this time, the application program correspondingly displays a signal that the key is clashed because the program has stored the wave corresponding to the number key 6. In the condition, the user may modify the control signal corresponding to the previous number key 3 by displaying the image.

A second possibility (the sub-flow II) is that the key previously pressed by the user is correct, and the current input function key is wrong. For example, when the previous display image displays the number key 3, the user correspondingly input the number key 3 of the remote controller. However, when the display image displays the input of the number key 6, if the user presses the number key 3 of the remote controller, the application program correspondingly displays the prompt information that the key is clashed because the query record has recorded the wave of the number key 3 corresponds to the function option 3. In the condition, the user may modify the function option of the current control signal by displaying the image.

A third possibility (the sub-flow III) is that the key of the remote controller corresponds to the function options of the computer iteratively. For example, the channel-switching key may represent switching in sequence or switching form-feed because of the different modes. When the computer provides the function options, the function options will not one-to-one correspond to the function keys of the remote controller. The amount of the function options provided by the computer may be larger than that of the function keys of the remote controller, thus a plurality of function options may simultaneously correspond to a same function key of the remote controller.

When the application program achieves the query record, it may use different data structures to achieve a method for storing the query record according to a preference of the user or an actual need in use. For example, it may use a lookup table to build the query record, or use a linking list to build the query record without influencing the use of the query record.

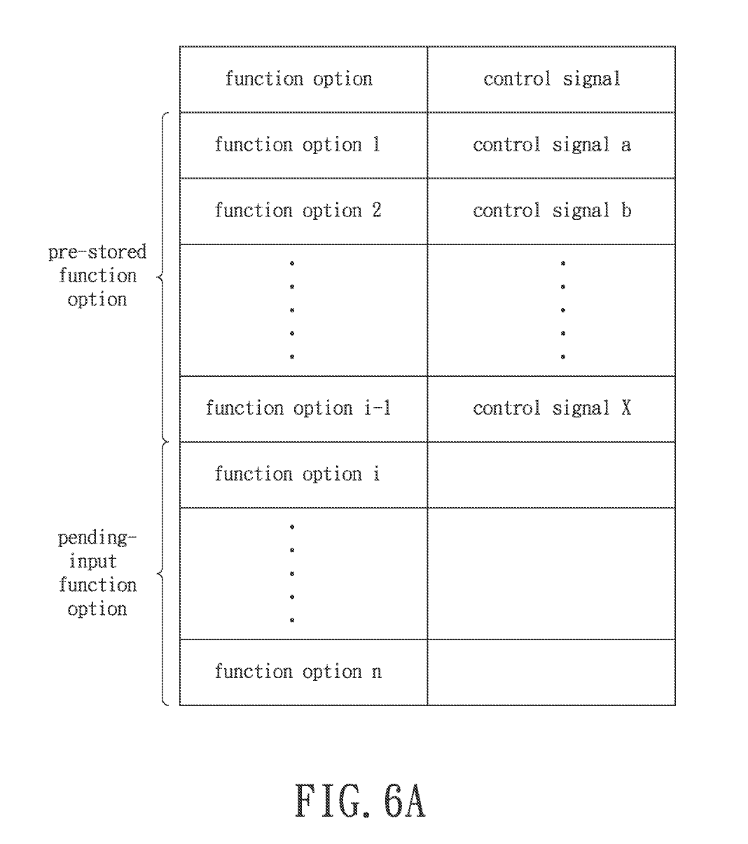

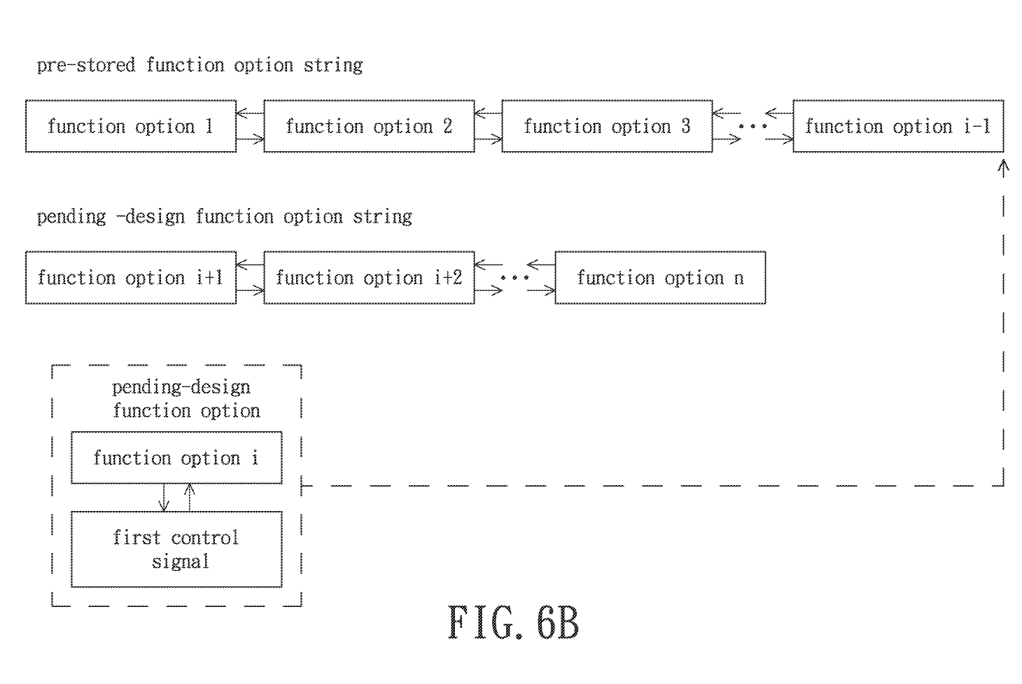

FIG. 6(A) is a schematic view of using the lookup table to build the query record in accordance with the present invention. In FIG. 6(A), each signal query record comprises fields of the function options and the corresponding control signals. If it is further divided into a pre-stored function option and a pending-design function option according to whether storing the corresponding control signal in operation, and the pre-stored function option and the corresponding control signal are disposed together. If being designed in sequence, when the user designs the i-th function option, it represents the query record has stored i-1 records, and the i-th function option is the object-design option at present.

The user inputs the first control signal according to the i-th function option prompted by the image, and the control unit compares the contents from the function option 1 to the function option i-1 of the memory unit. The function options which do not input the corresponding control signals may be arranged at a lower-half part of the query table.

FIG. 6(B) is a schematic view of using the linking list to build the query record. In the process flow of the program, the application program can use the linking list to record the pre-stored function option and the pending-input function option in series, and links the corresponding relation between the function options and the control signals of the query record by an index pointing mode.

No matter what of the data structure for storing the query record, the query record comprises the corresponding relationship between the function options and the control signals, such that the application program can perform the comparison program according to the query record. Any possible format for storing the data may be used.

The present invention also can provide a mode of the user selecting the corresponding input except for using the application software to provide the pending-input function option in sequence for prompting the user to input. Similarly, for the mode of pressing the key of the remote controller after selecting the function option, the present invention also provides the comparison function for the query record, to prevent the user from the mistaken operation by an instant confirming mode.

In summary, the present invention employs the dynamically comparison for the query record to improve the problem of the conventional art and make the whole learning flow more humanization. While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for storing control signals adapted into an electronic device and configured for receiving and storing control signals sent from a remote controller, the method comprising:
using the electronic device to receive a first control signal sent from the remote controller by pressing a first key of the remote controller;
performing a comparison program between the first control signal and a query record comprising a plurality of function options and a plurality of corresponding control signals;
dynamically displaying a function option of the function options and a corresponding modification prompt according to a result of the comparison program; and
updating and storing a control signal corresponding to the function option of the query record.

2. The method according to claim 1, wherein the step of using the electronic device to receive the first control signal sent from the remote controller by pressing the first key of the remote controller, comprises:
pressing the first key according to a pending input function option by a user; and
using the electronic device to receive the first control signal corresponding to the first key which is sent from the remote controller.

3. The method according to claim 1, wherein the function options of the query record are divided into a plurality of pre-stored function options and a plurality of pending-input function options.

4. The method according to claim 1, wherein the step of dynamically displaying the function option of the function options and the corresponding modification prompt according to the result of the comparison program, comprises:
displaying a pending-input function option and a modification prompt clashed with a pre-stored function option corresponding to the first control signal of the query record, if the result is a repeated result; and
displaying a modification prompt for storing the first control signal as the pending-input function option.

5. The method according to claim 4, wherein the step of displaying the pending-input function option and the modification prompt clashed with the pre-stored function option corresponding to the first control signal of the query record if the result is the repeated result, comprises:
displaying the repeated result through a prompt information; and
optionally modifying a control signal corresponding to the pre-stored function option or a control signal corresponding to the pending-input function option according to the prompt information by the user.

6. The method according to claim 5, wherein the step of updating and storing the control signal corresponding to the function option of the query record, comprises:
receiving a second control signal sent from the remote controller by pressing a second key of the remote controller; and
updating the control signal corresponding to the pre-stored function option as the second control signal, or storing the second control signal as the control signal corresponding to the pending-input function option, according to a judgment for the prompt information by the user.

7. The method according to claim 4, wherein the repeated result is that the query record has stored a corresponding relation between the first control signal and the pre-stored function option.

8. A computer product, comprising a software program stored therein, wherein the software program is performed to perform an operation for storing a control signal by an electronic device having a control unit, and the operation for storing the control signal comprises:
using the electronic device to receive a first control signal sent from a remote controller by pressing a first key of the remote controller;
performing a comparison program between the first control signal and a query record comprising a plurality of function options and a plurality of corresponding control signals;
dynamically displaying a function option of the function options and a corresponding modification prompt according to a result of the comparison program; and
updating and storing a control signal corresponding to the function option of the query record.

9. An electronic device, connected to a remote controller through signals and having a function of storing control signals sent from the remote controller, the electronic device comprising:
a transceiver, connected to the remote controller through the signals, and configured for receiving a first control signal sent from the remote controller by pressing a first key of the remote controller; and
a control unit, electrically connected to the transceiver, and configured for performing a comparison program between the first control signal and a query record comprising a plurality of function options and a plurality of corresponding control signals, and updating and storing a control signal corresponding to a function option of the function options of the query record, after dynamically displaying the function option of the function options and a corresponding modification prompt according to a result of the comparison program,.

10. The electronic device according to claim 9, further comprising:
a display unit, electrically connected to the control unit, and cooperated with the control unit to dynamically display the function option and the corresponding modification prompt.

11. The electronic device according to claim 9, further comprising:
a memory unit, electrically connected to the control unit, and configured for updating and storing the query record according to the comparison program performed by the control unit.

12. The electronic device according to claim 11, wherein the memory unit employs a look-up table mode or a data-linking mode for storing a corresponding relation between the plurality of function options and the plurality of control signals of the query record.

13. The electronic device according to claim 9, wherein the step of the control unit dynamically displaying the function option of the function options and the corresponding modification prompt according to the result of the comparison program, comprises: displaying a pending-input function option and a modification prompt clashed with a pre-stored function option corresponding to the first control signal of the query record if the result is a repeated result; and displaying a corresponding modification prompt for storing the first control signal as the pending-input function option if the result is an updated result.

14. The electronic device according to claim 13, wherein if the result is the repeated result, the control unit performs following steps: displaying the repeated result through a prompt information; and optionally modifying a control signal corresponding to the pre-stored function option or a control signal corresponding to the pending-input function option according to the prompt information by the user.

15. The electronic device according to claim 14, wherein the step of the control unit updating and storing the control signal corresponding to the function option of the query record, comprises: receiving a second control signal sent from the remote controller by pressing a second key of the remote controller; and updating the control signal corresponding to the pre-stored function option as the second control signal, or storing the second control signal as the control signal corresponding to the pending-input function option according to a judgment for the prompt information by the user.

16. The electronic device according to claim 13, wherein the repeated result is that the query record has stored a corresponding relation between the first control signal and the pre-stored function option.
